(19) United States
(12) Patent Application Publication
(10) Pub. No.: US 2023/0316201 A1
(43) Pub. Date: Oct. 5, 2023

(54) Computer-Implemented Dilemma and Uncertainty Planning

(71) Applicant: MITRE Corporation, McLean, VA (US)

(72) Inventors: Saurabh Mittal, McLean, VA (US); Rob Wittman, JR., McLean, VA (US); David L. Prochnow, McLean, VA (US)

(21) Appl. No.: 17/966,319

(22) Filed: Oct. 14, 2022

Related U.S. Application Data
(63) Continuation of application No. 17/713,842, filed on Apr. 5, 2022.

(51) Int. Cl. G06Q 10/06; G06Q 10/04

(52) U.S. Cl. CPC G06Q 10/06375; G06Q 10/06315; G06Q 10/04

(57) ABSTRACT

Contextual data is received and processed that characterizes a current state of resources of a competitor entity, included any targeted effects on the entity. The contextual data and desired adversarial effects are used to generate and/or update an effect-web plan and a dilemma topology graph. This comprises a plurality of desired effects, actions and task plans and a plurality of dilemmas to impose when prespecified conditions are met. Available team-systems to execute the effect-web plan and dilemma topology are then determined which result in deployment of effect-web plan by a selected team-system and at least one dilemma based on the dilemma topology graph. Data characterizing the multi-order impact of the deployment of the effect-web plan on the entity and the imposition of the at least one dilemma are monitored to quantify the increased uncertainty in perceived decision-making of the entity so that iterative modifications can be subsequently guided and implemented.

### CROSS REFERENCE TO RELATED APPLICATIONS

This application is a continuation-in-part of U.S. application Ser. No. 17/713,842, filed Apr. 5, 2022. The foregoing related application, in its entirety, is hereby fully incorporated by reference.

### TECHNICAL FIELD

The subject matter described herein relates to computer-implemented techniques and specification for a computer-implemented Dilemma and Uncertainty Planning and Control System (DUPCS) for selectively configuring constrained resource systems in a modular team-system to produce one or more effects for increasing uncertainty and computer-implemented dilemma plans so as to degrade a competitor's ability to gauge its own performance in a shared environment or to undertake harmful actions.

### BACKGROUND

Increasing amounts of information about companies and other organizations and entities are available online and via various data feeds (including proprietary data feeds). This information can characterize the operations of such companies and other organizations and entities (e.g., competitors, opposing military, etc.) including historical actions and performance as well as projected future performance.

### SUMMARY

In a first aspect, contextual data characterizing a current state of resources of an entity is received and processed. In addition, data specifying desired adversarial effects against the entity is received and processed. The contextual data and desired adversarial effects are used to generate an effect-web plan comprising a plurality of effects, actions and task plans to implement the desired adversarial effects and a dilemma topology comprising a graph specifying a plurality of dilemmas to impose when prespecified conditions are met. Available team-systems to execute the effect-web plan and dilemma topology are then determined (i.e., identified, etc.) which results in the generated effect-web plan being deployed by a selected team-system and at least one dilemma based on the dilemma topology graph being imposed. Data characterizing the multi-order impact of the deployment of the effect-web plan on the competitor and the imposition of the at least one dilemma are monitored. In some implementations, the multi-order impact of the deployment of the effect-web plan on the competitor and the imposition of the at least one dilemma can be visualized in a graphical user interface (e.g., a dashboard, etc.). One more of the generated effect-web plan or the dilemma topology can be modified and deployed based on the monitoring to increase a likelihood of an occurrence and success of the desired adversarial effects.

The resources of the entity can include one or more of: people, processes, or technology resources of the entity.

The team-systems can include an ensemble of information gatherer systems, network builder systems and performer systems.

The generated effect-web plan and dilemma topology can be deployed as part of a computer-implemented simulation.

The available team-systems can be determined using a multi-objective constraint optimization algorithm. The available team-systems can be ranked using one or more machine learning models or other techniques and the top ranked team-system can be selected (or top team-systems selected).

The contextual data can take various forms including competitor identification and state data and/or executive strategy data and/or effect instrumentation data.

The contextual data can be received from one or more of a gatherer system data feed, a network builder system, or a performer system. In addition or in the alternative, the contextual data can comprise simulation data.

In some variations, a plurality of sensors (or data feeds) can be deployed to obtain the contextual data. The sensors can take various forms including hardware-based sensors including a processor and memory and/or software-based sensors configured to obtain data and synthesize contextual data from differing data sources. The sensors can provide the monitored data for effect instrumentation.

The received contextual data can include competitor state variables. With these variations, the generation of the effect-web plan and dilemma topology can include applying game theory to specify one or more computer-implemented identified actions to evaluate the competitor state variables operating within a pre-defined range.

The effect-web plan and dilemma topology can be generated so as to influence a subset of the competitor state variables comprising end-state variables. Effects deployed by the effect-web plan can cause one or more of the end-state variables to change over time in a desired direction as quantified through an uncertainty score.

New tasks and schedules can be formulated by iteratively matching constraints applicable to the information gatherer systems, performer systems and/or network builder systems within the team-system. These formulated new tasks and schedules can be deployed by the team-system configuration in a simulated or real environment.

Control on uncertainty associated with end-state variables can be established such that at least one of the deployed effects targets the competitor state variables having the associated uncertainty in an operating range of the competitor state variables.

Systems are also provided for computer-implemented dilemma and uncertainty planning having at least one data processor and memory storing instructions to implement various aspects as provided herein. The systems can also include a plurality of information gatherer systems, a plurality of network builder systems, and/or a plurality of performer systems.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating components forming part of an Dilemma and Uncertainty Planning and Control System (DUPCS);

FIG. 2 is a first diagram illustrating a dilemma specification, design, and control system;

FIG. 3 is a diagram illustrating an effect and uncertainty design algorithm with dilemma imposition;

FIG. 4 is a diagram illustrating an effect and uncertainty control system utilizing a dilemma topology;

FIG. 5 is a diagram illustrating dilemmas imposed by a first entity (owner) and corresponding actions and perceptions of a second entity (competitor or adversary);

FIG. 6 is a process flow diagram for implementing effect and uncertainty strategy utilizing a dilemma topology; and

FIG. 7 is a diagram of a computing device for implementing aspects directed to uncertainty control.

### DETAILED DESCRIPTION

The current subject matter is directed to advanced computer-implemented techniques and computing architectures for instituting effect-web plans by an entity A, also known as DUPCS “owner” for an entity B. Entity B, can for example, be A's business competitor or other form of adversary. The effect-web plans can result in a desired adversarial effect or result such as increasing uncertainty and confusion for the entity B to disrupt B's normal state or a decrease in gauging B's own performance in a shared marketplace. A shared marketplace, as provided herein, is an environment in which performer systems, network builder systems and information gatherer systems exchange information, goods and services in a zero-sum game for incentives such as an increase in geographical territory or increased number of consumers of information, goods and services. Examples of a shared marketplace include business markets for incentives of greater product penetration, social media for incentives such as dominant narratives, or military battlespace with incentives such as capture of adversary territory.

The current subject matter is also directed to computer-implemented dilemma topology engineering. In this context, dilemma refers to a situation in which a difficult choice has to be made between two or more alternatives, especially equally undesirable ones—situational judgements made under duress that have a higher probability of error, and thereby, a higher probability of disadvantage. In a competitive context, to impose a dilemma is to cause a situational judgement under stress with an expectation of a higher probability of competitor (or enemy) error (or a worse outcome than expected). Further, the current subject matter is directed to dilemma topology which specify a relationship between existing dilemmas and their interdependency describing the dilemma landscape/space. Related topology engineering can be implemented to ensure dilemma space is never empty across the campaign timeline. Further, dilemma shaping can be deployed which provides scientific methods to establish controls for navigating and designing dilemma topologies.

As used herein, the term “owner” (entity A) can refer to the initiator of the algorithms provided herein in relation to one or more competitors. The term “competitor state variable” (CoSV) can refer to a variable that corresponds to some aspect of an entity B's overall state or a state that pertains to a particular issue, circumstance, people, process and/or technology. The term “range of CoSV” can refer to the operating range of the variable. Range of CoSV can be either qualitative or quantitative but not both. A qualitative range is a Boolean state (true/false encoded as 1 or 0). A quantitative range can be bounded within two thresholds: [lowerbound, upperbound], encoded as a floating-point number. The term “end state variable” (EnSV) can refer to a subset of CoSV that the owner intends to influence and has the technology and the means to do so. The owner typically has incomplete information about the corresponding CoSV operating range. Uncertainty of CoSV can refer to the difference between the bounded ranges of EnSV and CoSV variables. “Game theory strategies” can refer to the owner contextualizing competitor response per a library of game theory strategies such as Tit for Tat, Tit for 2 Tats, and many others. “Competitor state” CoSV for owner's use and targeted influence can be termed as a set of EnSVs. “Effect” can refer to a set of EnSVs that the owner can influence, instrument, and monitor in a spatiotemporal manner by its actions. Effect can be qualitatively denoted by: <no effect, partially effective or fully effective> and quantitatively denoted by Effect_n_i_score, where n_i is the i^{th} effect in a set of n effects. “Effect-Web” can refer to a set of effects with spatiotemporal characteristics. “Effect-Web state” can refer to an effect-web caused by the owner and can qualitatively result in: <no effect, partially effective or fully effective> and be quantitatively expressed as effect_web_score. “Dilemma” can refer to a set of EnSVs that can be affected concurrently with one or more effects. This subset is selected deliberately to bundle actionable EnSVs that contribute to an increased uncertainty at the competitor's end. An effect may or may not lead to dilemma if the degree to which an EnSV could be affected does not result in a response from the competitor. Each effect has a response indicator, which based on the owner's understanding of the competitor, determines if the effect has been successful, partially successful or failed, as quantified by Effect_n_i_score. Similarly, dilemma response indicators determine if a subset of EnSVs grouped as a “dilemma_i” match a quantified target UncertaintyScore. “Network builders systems” can comprise a set of systems that provide communication and control mechanisms to influence EnSVs. “Performer systems” can refer to a set of systems that produce an effect to indirectly influence EnSV ranges and uncertainty score. “Information gatherer systems” can refer to a set of systems that provide instrumentation (data feeds) to monitor EnSVs. “Action” can refer to an act that may be taken by a performer system to produce an effect. “Task” can refer to an action that is scheduled for a performer system in the future. “Team-system” can refer to a configuration of information gatherer systems, performer systems and network builder systems that collectively, as an Acknowledged SoS, act to deliver an effect.

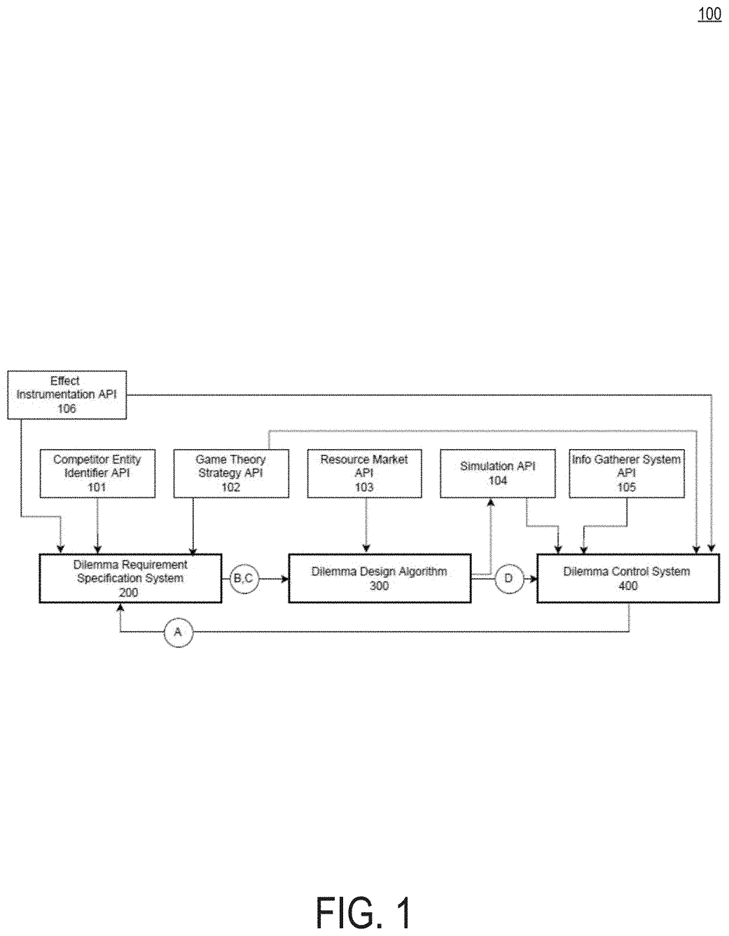

FIG. 1 is a diagram 100 illustrating an architecture of DUPCS in which various computing devices/computing device clusters 200, 300 and 400 may interact over a communication network (radio or software) depicted as used in A-D. Device 200 is an example of a dilemma requirement specification system for DUPCS which can be used to define the specifications of a dilemma. Device 300 is an example of system to implement a dilemma design algorithm, which in turn, implements the specified requirements to generate a dilemma. Dilemma control system is a device 400 that maintains control over effect-web and evaluates perceived competitor performance and takes corrective action for maintaining the structure of the effect-web. These computing devices 200-400 exchange data from various application programing interfaces (APIs) (101-106) that are either connected to live or simulated systems. Competitor identifier API (101) provides data about various competitor entities that are targeted by the DUPCS system. Game theory strategy API (102) provides information about strategies that define various actions within the effect-web plan. Resource market API (103) provides information about various resource systems (e.g., information gatherer systems, network builder systems and performer systems) that can be used to deliver effects and procure additional data for the entity's state. Simulation API (104) provides access to a simulation environment that characterizes the execution and progress of an imposed dilemma in a virtual analytics or experimentation environment. Info Gatherer System API (105) provides connections to available data sources and/or information characterizing the imposed dilemma and related activities. Effect Instrumentation API (106) provides a service for instrumenting or otherwise specifying effects that cause one or more dilemmas.

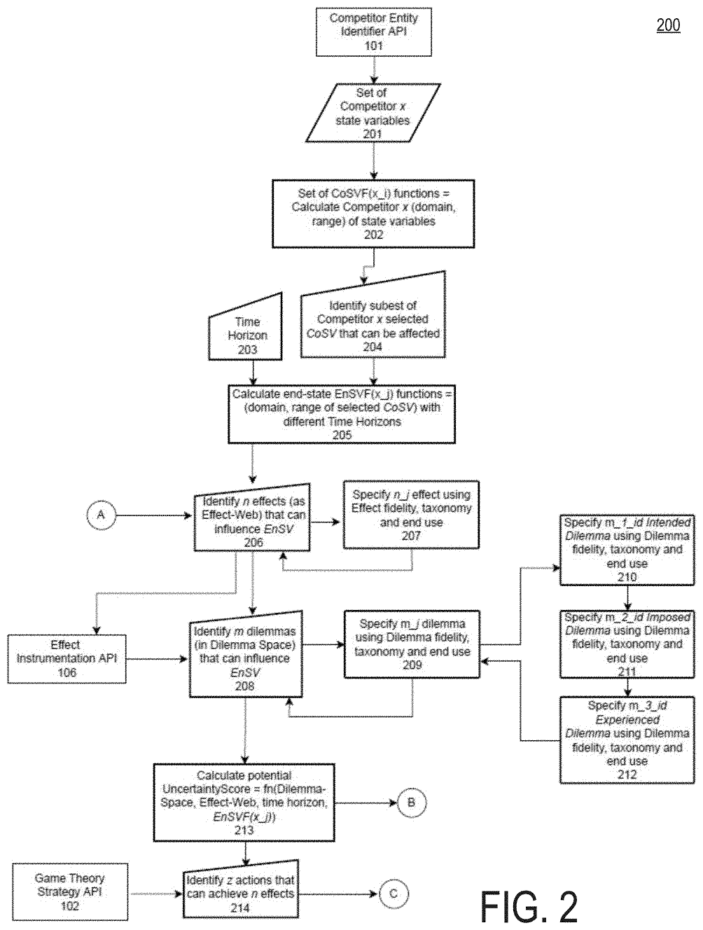

FIG. 2 is a diagram 200 illustrating the architecture and aspects for specifying requirements for a desired effect-web plan for at least one entity (e.g., competitor entity, etc.). Initially, at 201, a set of entity state variables (CoSV) are identified for a specific entity, which are transmitted over one or more computing networks by way of the competitor identifier API 101. These variables provide information about some aspect of an entity's overall state, such as geolocation of critical functional assets, vulnerability of such assets to get compromised, number of assets, modality of assets and/or temporal behavior of assets. An asset is something of “value” to an entity, for example, a physical facility, a technology, personnel, product, etc.

A subset of variables in 201 is further analyzed for their domain and range values in 202 to arrive at a set of mathematical functions CoSV(x_i) that identifies relationship between domain and range values, where x denotes a competitor x and i denotes a CoSV from a set of CoSVs for competitor x. A domain of CoSV(x_i) is the set of values for which the function CoSV(x_i) is defined. For example, let there be a competitor or adversary with a radar asset that has a maximum range of detection of 100 miles and is protected by munitions that can counterattack. A radar for an adversary is a competitor asset that provides deterrence. Let CoSVx_1=range of radar detection and CoSVx_2 be the number of munitions for counterattack are the two CoSVs. Let the known maximum value of CoSVx_1 be 100 miles and the maximum value of CoSVx_2 be 70. Accordingly, function CoSVF(x,1) is defined. A function f(x) such as CoSVF(x,1) can be “to decrease the detection range of radar”. Similarly, CoSVF(x,2) can be “reduce the number of munitions”. Further, the domain of CoSVF(x,1) can take the values: (destroy, degrade), that could fulfil the goal of decreasing the detection range. These results can be the two effects that will be requiring planning. Likewise, the domain values for CoSVF(x,2) can take value: (expend at least 90% of munitions). A range of function CoSVF(x,1) is the set of values CoSV(x_i) can take for a given set of domain values. For each of the identified domain values for CoSVF(x,1), viz., the range values for the domain: “destroy” can result in the interval [0,5] miles, and the range values for the domain: “degrade” can result in the interval [0,50] miles. Similarly, the range values for “expend” domain for CoSVF(x,2) can take the values in the interval [0,7]. From this set of CoSVF(x, i) functions, a subset can be manually selected in 204 that the DUPCS has the technology and means to affect. This selection can be based on multiple criteria such as technology, geography, understanding of various competitor variables and timeframes. For the running example, of these two CoSVs, CoSVF(x,1) can be selected for further consideration. Through manual input in 203 that specifies the time horizon to impact a CoSV(x_i) and a manual selection of a subset of j CoSVs from the set of i CoSVs, a set of end-state state variable functions EnSV(x_j) for different time horizons in 205 are defined that DUPCS can affect. For the current example, let the time horizon be in the interval [1,6] hours and EnSV(x,1)=CoSVF(x,1). A function EnSVF(x,1), then, is defined for time horizon tH1=2 hours for (domain, range)=(degrade, [50,100]miles), and another function EnSVF(x,2) is defined for time horizon tH2=5 hours for (domain, range)=(destroy, [0,5] miles). The target EnSVF(x,1) functions are then further reviewed manually in 206 to identify i indirect effects in the shared marketplace that could influence the range values for EnSVF(x) functions. For this example, two effects have now been identified EnSVF(x,1): degrade by Cyber effect and EnSVF(x,2): destroy by kinetic effect. For each of the i effects identified in 206, effects are specified using effect taxonomy, fidelity, and end use aspects 207. Effect taxonomy includes effect classification such as kinetic effects or non-kinetic effects. Kinetic effects include direct fires or indirect damage by kinetic performer systems. Non-kinetic effects include effects resulting from a cyberattack or electronic attack or disruption in accessibility and communication without any kinetic means such as psychological operations. Effect fidelity can include aspects such as the set of EnSV(x_j) range values, purpose, spatial location time horizon, granularity, duration, geographical size, and number of other EnSVs affected by the effect. For the current example, EnSVFx1(degrade) results in [range=(0, 50), purpose=“disruption”, spatial location=(lat, long), time horizon=2 hr, granularity=“campaign”, duration=1 hr, geographical size=radius of 50 miles, number of other EnSVs affected=0). Effect purpose attribute can include semantic association of effect for a given purpose such as disruption, deactivation, destroying of a competitor resource, suppression, delay, illumination, and enhancement of an existing effect.

Data characterizing the n effects can be provided (from module 206) to the effect instrumentation API 106. The effect instrumentation API 106 sends a list characterizing such effects to module 208 which can identify m dilemmas in a dilemma space that can influence a subset of EnSVs. The dilemma space can include m dilemmas which can be formed from various types of dilemmas types (collection of various subsets of EnSVs) specified according to competitor B response indicators as one or more of intended dilemmas 210, imposed dilemmas 211, and experienced dilemmas 212. These three type of dilemmas 210-212 can be respectively specified using dilemma fidelity, taxonomy and end use (i.e., a set of rules specifying conditions triggering imposition of dilemmas, etc.). Intended (Perceived) dilemma 210, in this context, can be the owner's desired outcome of a dilemma (prior to its imposition by the owner entity relative to a second entity competitor B). Imposed dilemma 211 can characterize the actual imposed dilemma by the Owner entity relative to a second entity, which the owner entity can validate. The experienced dilemma 212 can characterize the second entity's actions in response to the imposed dilemma (which, in turn, can quantify the degree to which the imposition of the dilemma is successful, etc.).

The specification of all the n effects and m dilemmas is then used to calculate an uncertainty risk score in 213, which can be value derived from an aggregate of which is a function of the dilemma space, time horizon, and the EnSV space. An uncertainty score quantifies the risk associated with achieving an effect, and associated dilemmas within a given time horizon. In one variation, the uncertainty score is the ratio of identified domain range in EnSVFx with the operational maximum value of the CoSVx normalized over the time horizon. For example, as the objective of DUPCS is to degrade competitor's ability to gauge its own performance, the uncertainty score for EnSVFx1(degrade) will be higher than the EnSVFx2(destroy). Consequently, the selection of “degrade” over “destroy” effect will be preferred within the effect-web plan. The uncertainty risk score for the overall effect-web is aggregated from the constituent uncertainty scores of each of the effects and can be further normalized by the number of effects and aims to rank-prioritize and minimize the needed effects. This uncertainty score for each effect and its constituent fidelity attributes are then used in 214 to arrive at various actions (through manual input) that could be performed to produce the effects in a simulated or real environment. For example, for EnSVFx1(degrade), the action selected is cyber-attack, and the EnSVFx2(destroy), the action selected is kinetic strike. The identified set of actions are validated through game theory strategy API 102 that evaluates actions sequences per game theory, such as Tit for Tat, Tit for 2 Tat, etc. In some variations, operation 214 can specify strategies to incorporate from operation 213 and related executive control aspects. Executive control strategies can include parameters resulting from the evaluation of strategies, team-system formation recommendations and prior experience of executive task planners. For example, to achieve a degrade effect, a cyber-attack, if possible, provides a clean execution with minimum casualties. Alternatively, a destroy effect must be a kinetic activity to rule out any reboot or restart of the radar target asset. This process allows quality assurance processes to be performed (e.g., a sanity check by experienced personnel). Rankings of the strategies and/or implementation schedules (single event, recurring every day, recurring every week, etc.) can be specified.

A simulated environment can be implemented through a computer-based simulation tool that executes the effect-web plan either using discrete event simulation (e.g., Discrete Event Systems [DEVS] formalism, agent-based modeling (NetLogo, Repast, etc.), or tools like Arena, Simio, and Anylogic), continuous system simulation (e.g., mathematical differential equations) or hybrid simulation approaches (that include both discrete and continuous approaches simultaneously). A real environment that may execute an effect-web plan can comprise human-machine system-teams that refine various aspects of effect-web plan before tasks are executed by human-machine teams.

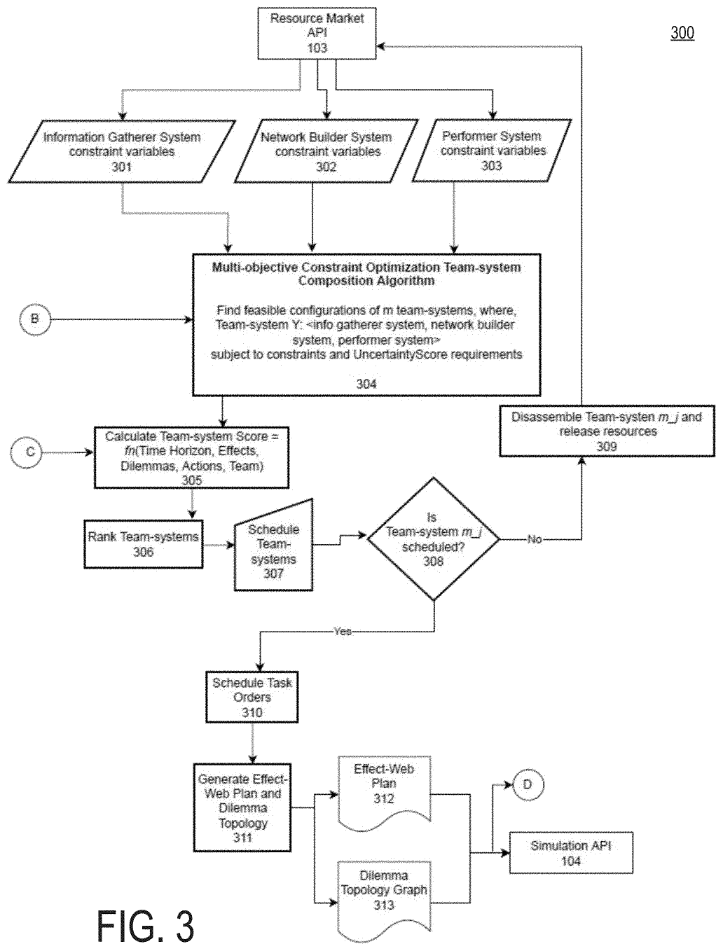

FIG. 3 is a diagram 300 that describes a Multi-Objective Constraint Optimization Team-system Composition (MOCOTeC) algorithm 304 that receives the uncertainty score from operation 208 as requirement specifications to arrive at a team-system configuration while satisfying, for example, three type of constraints: information gatherer system constraints 301, network builder system constraints 302 and performer system constraints 303, to produce an executable effect-web plan. Information gatherer systems can be sensor systems that obtain data characterizing the entity and the frequency of data collection (e.g., continuous, seconds, minutes, hours, days, etc.). Constraints on the information gatherer systems can also be defined (for example, their sampling rate, their operational thresholds, data formats, communication channels, etc.) The network builder systems that are available (i.e., the set of systems that provide communication and control mechanisms to influence EnSVs) can be identified. These systems may be operating at different frequencies (e.g., continuous, seconds, minutes, hours, days, etc.). Some examples of network builder systems include mobile sensors or drones that provide hub-like functionality to create dynamic communication networking, coordination, and control to connect owner resources dynamically. Constraints on the network builder systems can also be defined, for example, network communication protocol, window of availability, interoperability mechanisms, time to setup, etc. In addition, available performer systems can be identified (i.e., a set of systems that produce an effect to indirectly influence EnSVF(x,j) range values. These systems can also be operable at different frequencies (e.g., continuous, seconds, minutes, hours, days, etc.). For example, performers can be owner assets that can produce a cyberattack disrupting an entity's operation or a kinetic/physical attack that destroys the entity asset completely. Constraints on the performers can also be defined, such as time of availability, time of scheduling, success probability, power capacity, etc. These three types of resources can be accessible through resource market API 103 that notifies of available resources and applicable constraints within a given time horizon. The objective functions and/or utilized machine learning models used by the MOCOTeC algorithm can optimize team-system configuration for criteria like time horizons, fewest number of actions, minimum number of effects, availability of at least two effects in effect-web and the like. These multiple criteria for a given resource system can be aggregated in a reliability score for that resource. Various team configurations in 304 can then be scored, at 305, and aligned with a suggested game theory strategy API 102 recommendation identified in 214. The scored teams can be optimal solutions to the MOCOTeC algorithm subject to different optimization criteria. For example, the scores can be generated as a function of time horizon, effects, dilemmas, actions, and available teams. The optimization can be based on identifying team configurations with high reliability scores for network builder system, information gatherer system and performer system taken together and associated with the earlier identified uncertainty risk score for a given time horizon. The pareto optimal solutions can be gathered from two categories, viz., (high reliability, low risk) and (high reliability, high risk), among the four team-system reliability and risk pairing categories. For example, while an ideal (team-system configuration) solution with high reliability and low risk has a higher probability of delivering a successful effect, a solution with high reliability and high risk may get selected in adverse circumstances. Another category for low reliability, low risk can be further considered for any experimental activity, if the situation so warrants. This operation leads to ranking of team-system configurations at 306 followed by scheduling of ranked teams at 307 through manual input. If the team-system can be successfully scheduled at 308 due to availability of team-system participants, task orders can be computationally created involving a combination of sequential and parallel arrangements subject to participant system's availability constraints. Tasks are scheduled for the given time horizon, at 310, otherwise, the team-system is disassembled and released back to the resource market API 103. The scheduled task orders 310 are aligned with the corresponding effects to generate an effect-web plan and dilemma topology graph 311. The effect-web plan component 112 along with a corresponding dilemma topology graph 313 (forming par to the dilemma topology 311) can then be used for execution in a simulated environment (e.g., via Simulation API 104) or in a real environment. The dilemma topology graph 313 can be a connected graph of selected and connected dilemmas forming, in effect, a decision tree such that certain dilemmas are imposed or otherwise triggered based on certain conditions being met as evident through instrumentation APIs in 106.

The effect-web plan in 312 is of the structure/schema, constituting, for example, a matrix with columns: time horizon, echelon level specifying authority over resources in a team-system configuration, resource availability, EnSVF(x,j) domain values, effect specifications, EnSVF(x,j) range values, team configuration and/or task orders. Other elements can be utilized depending on the desired configuration fidelity. For an executable effect-web plan, the matrix will have at least two rows indicating at least two effects within an effect-web, where each row is an instantiation of a team-system configuration and related information in other columns tasked to deliver the effect. As noted above, an effect-web can be defined as a confluence of multiple effects to influence CoSV in more than one way.

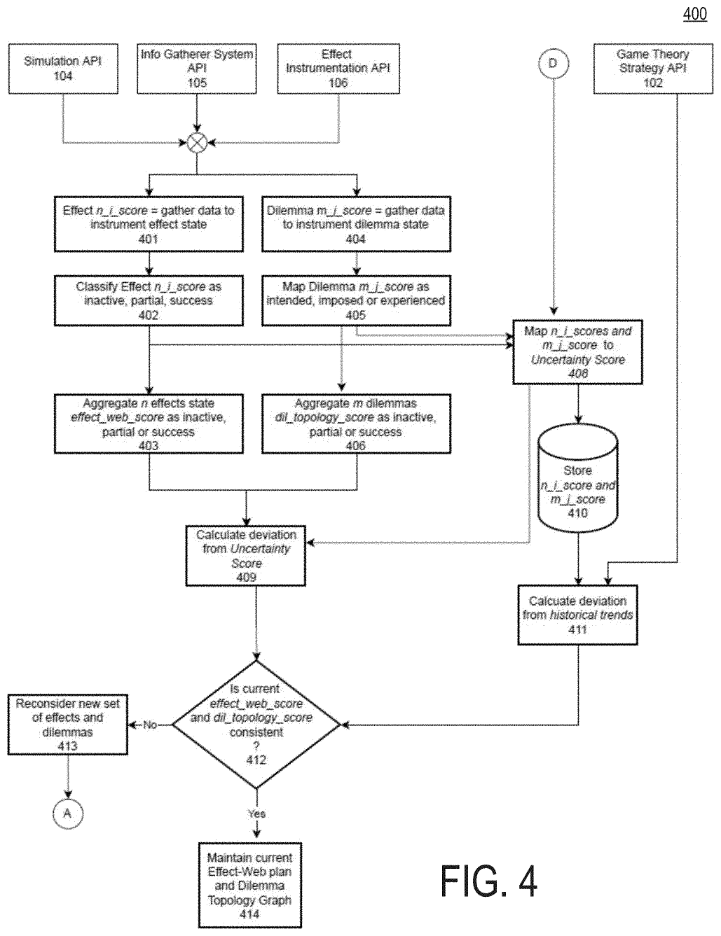

FIG. 4 is a diagram 400 that describes an architecture and method for controlling the effect-web and tracking uncertainty risk score once a team-system configuration starts executing their tasks and/or dilemmas in a simulated or real environment. The tracking is done through data arriving from simulation API 104, information gatherer system API 105, and effect instrumentation API 106. This multi-modal data can arrive at different frequencies (seconds, minutes, hours or days). This data can correspond to various EnSVF(x,j) range variables. The range values can be calculated based on the domain values for each EnSVF(x,j) and its deviation from the expected range value is calculated in “Effect_n_i_score” at 401. Qualitatively, no deviation (probability of occurrence p<0.2) from expected range value yields “inactive” effect, a significant deviation (0.2<p<0.8) as “partial” and a large deviation (p>0.8) as “success” effect. The quantified values can be normalized using regression model, fuzzy logic, machine learning logistic regression on EnSVF(x) functions for each effect in 402 and in aggregate for the entire effect-web in 403. Similarly, Dilemma m_j_score is calculated in 404 and mapped to intended, imposed or experienced as fail, successful or partial, respectively, using logistic regression in 405. Each Effect_n_j_score in 402 and Dilemma m_j_score in 405 can also be mapped to uncertainty score in 408 (along with dilemma scores) to calculate deviation from uncertainty score in 409, and can be further stored in a database 410 for regression analysis and historical trend analysis in 411 in which the respective effect and dilemma scores are mapped to the uncertainty score. Deviation of each effect and/or dilemma from the uncertainty score in 409 can be aggregated to calculate the overall deviation for the effect-web in 412. This deviation and the deviation from historical trend analysis can be merged to quantify the current effect-web and/or dilemma performance in 411. The historical data stored in the database 410 can characterize information about a team-system's and/or a dilemmas' performance and reliability over a period of time in achieving an effect and associated dilemmas with a specified fidelities. Based on different situations, the instrumentation of an effect needs to be normalized with historical data to arrive at an objective assessment of team-system's reliability and uncertainty scores for achieving that effect and the resulting dilemmas. The current subject matter is technically advantageous in that it ensures the team-system's and its constituent resource system's performance is evaluated in a non-contextual manner, which is essential to understanding the reliability and uncertainty associated with any give resource system and the resulting team-system to achieve an effect and the resulting dilemmas. If both the deviations are in the same positive direction, then the current effect-web plan and dilemma topology graph is to be maintained in 414. If they are both in the same negative direction, the current effect-web plan is to be maintained in 414 as well, which indicates that the current trajectory is yet to yield results and more resources (as team-systems) need to be applied. If they are in opposite directions, then a new set of effects need to be considered in 413, which eventually notifies the decision maker to reconsider the current effect-web plan in 206 and/or and the associated dilemma topology graph in 208 (not shown).

Further, feasible actions can be defined in 214 and associated tasks in 310 (i.e., actions and tasks that can be taken by a performer to produce an effect and/or dilemma). For example, these actions can include operations such as launching a drone sensor swarm for gathering new data feeds, launching a cyberattack, launching physical strikes, etc. The effect(s) and/or dilemmas can, in some variations, be implemented by a team-system (i.e., a combination of coordinated computing systems and/or computer-implemented processes) comprising a specified configuration of information gatherer systems, performer systems and network builder systems that collectively act to deliver an effect. The actions can be implemented via one or more tasks executed by a performer system.

As noted above, if the effect-web score is not consistent with the historical trend in 412, trajectory needs to be altered, then, at 413, attributes of the effect-web plan and/or dilemmas can be modified until the desired effect/uncertainty score is obtained. As part of creating effects, available network builder systems that are not constrained along with available performer systems that are not constrained can be identified or otherwise established. As part of the effect-web creation, a dominant game theory strategy can be identified that yields one or more effects within the effect-web. Based on the identified dominant strategy, a new target range for the competitor state variables can be established (e.g., by way of Game Theory Strategy API 102) over different time periods/on different time-bases.

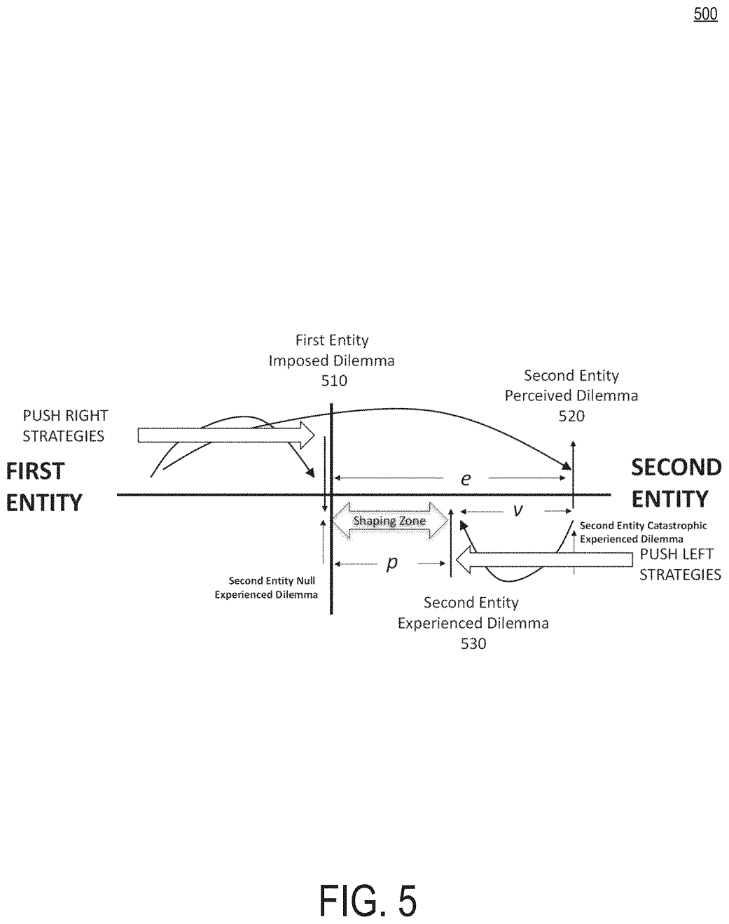

FIG. 5 is a diagram 500 illustrating the application of dilemma taxonomy in which at 510, an imposed dilemma is deployed by a first entity (owner) relative to a second entity (competitor B). The goal of the dilemma deployment is to have the second entity perceive the dilemma 520 as being more critical thus increasing the likelihood of the second entity making an error in addressing the deployed entity. The second entity's experienced dilemma 530 can validate the second entity's actions in response to the first entity's imposed dilemma 510 and the degree to which the first entity has become successful in achieving the intended dilemma. In some cases, there can be a null dilemma which can be perceived by the second entity as a non-dilemma which may cause uncertainty or damage on the second entity that is undetectable. Further, there can be a deployed dilemma that ideally ends up in the second entity making a catastrophic decision by the second entity. The dilemma topology graph can take into account various factors in determining which effect and/or dilemma to employ or discontinue. These factors can include a dilemma resolution error (e) between the perceived dilemma 520 and the imposed dilemma 510 which can guide the first entity strategies. This error (0.0-1.0) quantifies the degree to which an imposed dilemma (confirmed validation by the first entity though various APIs 104, 105 and 106) has resulted in achieving the intended dilemma. An optionality impact value (v) between the perceived dilemma 520 and the experienced dilemma guides the second entity strategies. This value (0.0-1.0) quantifies the degree to which the second entity is experiencing the dilemma, and is calculated based on the distance from the first entity's intended dilemma values. Further, there can be a perception error (p) between the imposed dilemma 510 and the experienced dilemma 530 (an inferred value of subtracting v from e) which, again, can be used to guide the first entity strategy.

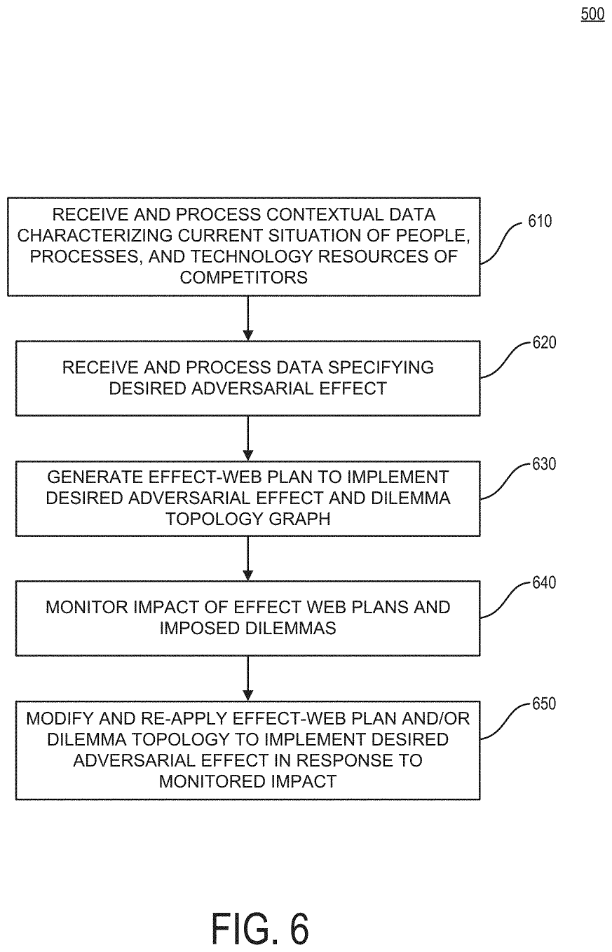

FIG. 6 is a process flow diagram 600 in which, at 610, contextual data is received and processed that characterizes a current state of people, processes, and technology resources of a competitor as multiple situation contexts through various CoSVs. In addition, at 620, data comprising desired adversarial effects against the competitor is received and processed. Using this received and processed data, at 630, an effect-web plan and a dilemma topology graph are generated based on the contextual data and the desired effects requirements. The effect-web plan includes a plurality of effects, actions and task plans to implement the desired adversarial effects. The dilemma topology graph specifies triggers for imposition of dilemmas. Thereafter, available team-systems to execute the effect-web plan (and associated dilemma topology) are determined. The generated effect-web plan can be deployed by a selected team-system (e.g., a top ranked team-system, etc.) and/or the dilemmas can be deployed by the selected team-system. Data characterizing a multi-order impact of the deployment of the effect-web plan and/or the dilemmas on the competitor entity can, at 640, be monitored. One or more of the generated effect-web plan and dilemma topology can be modified and deployed, at 650, based on the monitoring so as to increase a likelihood of an occurrence and success of the desired adversarial effects.

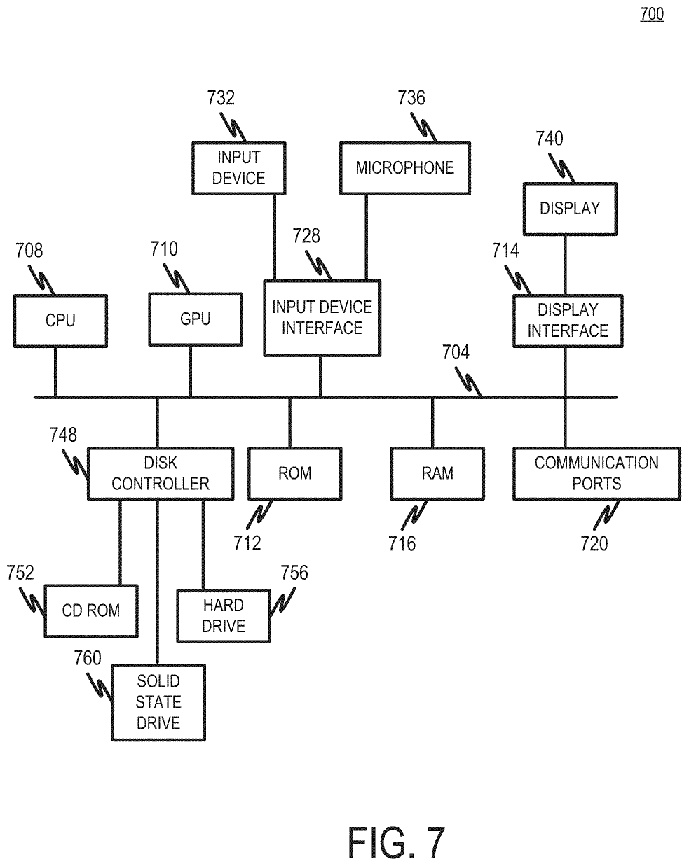

FIG. 7 is a diagram 700 illustrating a sample computing device architecture for implementing various aspects described herein. A bus 704 can serve as the information highway interconnecting the other illustrated components of the hardware. A processing system 708 labeled CPU (central processing unit) (e.g., one or more computer processors/data processors at a given computer or at multiple computers), can perform calculations and logic operations required to execute a program. In addition, a processing system 710 labeled GPU (graphics processing unit) (e.g., one or more computer processors/data processors at a given computer or at multiple computers), can perform calculations and logic operations required to execute a program. A non-transitory processor-readable storage medium, such as read only memory (ROM) 712 and random access memory (RAM) 716, can be in communication with the processing system 708 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 748 can interface with one or more optional disk drives to the system bus 704. These disk drives can be external or internal floppy disk drives such as 760, external or internal CD-ROM, CD-R, CD-RW or DVD, or solid state drives such as 752, or external or internal hard drives 756. As indicated previously, these various disk drives 752, 756, 760 and disk controllers are optional devices. The system bus 704 can also include at least one communication port 720 to allow for communication with external devices either physically connected to the computing system or available externally through a wired or wireless network. In some cases, the at least one communication port 720 includes or otherwise comprises a network interface.

To provide for interaction with a user, the subject matter described herein can be implemented on a computing device having a display device 740 (e.g., a CRT (cathode ray tube) or LCD (liquid crystal display) monitor) for displaying information obtained from the bus 704 via a display interface 714 to the user and an input device 732 such as keyboard and/or a pointing device (e.g., a mouse or a trackball) and/or a touchscreen by which the user can provide input to the computer. Other kinds of input devices 732 can be used to provide for interaction with a user as well; for example, feedback provided to the user can be any form of sensory feedback (e.g., visual feedback, auditory feedback by way of a microphone 736, or tactile feedback); and input from the user can be received in any form, including acoustic, speech, or tactile input. The input device 732 and the microphone 736 can be coupled to and convey information via the bus 704 by way of an input device interface 728. Other computing devices, such as dedicated servers, can omit one or more of the display 740 and display interface 714, the input device 732, the microphone 736, and input device interface 728.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
receiving and processing contextual data characterizing a current state of resources of an entity;
receiving and processing data specifying desired adversarial effects against the entity;
generating, based on the contextual data and desired adversarial effects, an effect-web plan comprising a plurality of effects, actions and task plans to implement the desired adversarial effects and a dilemma topology comprising a graph specifying a plurality of dilemmas to impose when prespecified conditions are met;
determining available team-systems to execute the effect-web plan and dilemma topology;
causing the generated effect-web plan to be deployed by a selected team-system and imposing at least one dilemma based on the dilemma topology graph;
monitoring data characterizing multi-order impact of the deployment of the effect-web plan on the competitor and the imposition of the at least one dilemma; and
modifying and deploying one or more of the generated effect-web plan or the dilemma topology based on the monitoring to increase a likelihood of an occurrence and success of the desired adversarial effects.

2. The method of claim 1, wherein the resources of the entity comprise one or more of: people, processes and technology resources of the entity.

3. The method of claim 1, wherein the team-systems comprise an ensemble of information gatherer systems, network builder systems and performer systems.

4. The method of claim 1, the generated effect-web plan and dilemma topology is deployed as part of a computer-implemented simulation.

5. The method of claim 1, wherein the available team-systems are determined using a multi-objective constraint optimization algorithm.

6. The method of claim 1, wherein the available team-systems are ranked using one or more machine learning models.

7. The method of claim 1, wherein the contextual data comprises competitor identification and state data.

8. The method of claim 1, wherein the contextual data comprises executive strategy data.

9. The method of claim 1, wherein the contextual data is received from one or more of a gatherer system data feed, a network builder system, or a performer system.

10. The method of claim 1, wherein the contextual data comprises simulation data.

11. The method of claim 1 further comprising:
deploying a plurality of sensors to obtain the contextual data.

12. The method of claim 11, wherein at least a portion of the sensors comprise hardware-based sensors including a processor and memory.

13. The method of claim 11, wherein at least a portion of the sensors comprise software-based sensors configured to obtain data and synthesize contextual data from differing data sources.

14. The method of claim 11, wherein the plurality of sensors further provides the monitored data for effect instrumentation.

15. The method of claim 1, wherein the received contextual data comprises competitor state variables, wherein the generation of the effect-web plan and dilemma topology comprises:
applying game theory to specify one or more computer-implemented identified actions to evaluate the competitor state variables operating within a pre-defined range.

16. The method of claim 1, wherein the effect-web plan and dilemma topology are generated so as to influence a subset of the competitor state variables comprising end-state variables.

17. The method of claim 16, wherein effects deployed by the effect-web plan cause one or more of the end-state variables to change over time in a desired direction as a quantified through an uncertainty score.

18. The method of claim 3 further comprising:
iteratively matching constraints applicable to the information gatherer systems, performer systems and/or network builder systems within the team-system to formulate new tasks and schedules to deploy the team-system configuration in a simulated or real environment.

19. The method of claim 18 further comprising:
establishing control on uncertainty associated with end-state variables, wherein at least one of the deployed effects targets the competitor state variables having the associated uncertainty in an operating range of the competitor state variables.

20. The method of claim 1 further comprising:
ranking the available team-systems; and
wherein the selected team is a top ranked team.

21. The method of claim 1 further comprising:
visualizing the multi-order impact of the deployment of the effect-web plan on the competitor and the imposition of the at least one dilemma in a graphical user interface.

22. A system comprising:
at least one data processor; and
memory storing instructions which, when executed by the at least one data processor, result in operations comprising:
receiving and processing contextual data characterizing a current state of resources of an entity;
receiving and processing data specifying desired adversarial effects against the entity;
generating, based on the contextual data and desired adversarial effects, an effect-web plan comprising a plurality of effects, actions and task plans to implement the desired adversarial effects and a dilemma topology comprising a graph specifying a plurality of dilemmas to impose when prespecified conditions are met;
determining available team-systems to execute the effect-web plan and dilemma topology;
causing the generated effect-web plan to be deployed by a selected team-system and imposing at least one dilemma based on the dilemma topology graph;
monitoring data characterizing multi-order impact of the deployment of the effect-web plan on the competitor and the imposition of the at least one dilemma; and
modifying and deploying one or more of the generated effect-web plan or the dilemma topology based on the monitoring to increase a likelihood of an occurrence and success of the desired adversarial effects.

22. The system of claim 21 further comprising:
a plurality of information gatherer systems;
a plurality of network builder systems; and
a plurality of performer systems.

23. The system of claim 22, wherein the operations further comprise:
iteratively matching constraints applicable to the information gatherer systems, performer systems and/or network builder systems within the team-system to formulate new tasks and schedules to deploy the team-system configuration in a simulated or real environment.

24. The system of claim 23, wherein the operations further comprise:
establishing control on uncertainty associated with end-state variables, wherein at least one of the deployed effects targets the competitor state variables having the associated uncertainty in an operating range of the competitor state variables.
